(19) United States
(12) Patent Application Publication
(10) Pub. No.: US 2017/0103449 A1
(43) Pub. Date: Apr. 13, 2017

(54) IN-LIBRARY LENDING ACTIVATION

(71) Applicant: BIBLIOTHECA RFID LIBRARY SYSTEMS AG, Rotkreuz (CH)

(72) Inventors: Matthew D. Moore, Lake Elmo, MN (US); Joel J. Bradley, Woodbury, MN (US); Jennifer N. Crane, Woodbury, MN (US); Naveen Kalkur, White Bear Lake, MN (US); Thomas C. Mercer, Eagan, MN (US); Terry S. Nees, Shoreview, MN (US); Emily M. Van Vliet, Inver Grove Heights, MN (US)

(21) Appl. No.: 15/384,585

(22) Filed: Dec. 20, 2016

Related U.S. Application Data
(63) Continuation of application No. 13/489,002, filed on Jun. 5, 2012.

(51) Int. Cl. G06Q 30/06; H04W 4/02

(52) U.S. Cl. CPC G06Q 30/0645; H04W 4/021

(57) ABSTRACT

An electronic book (ebook) lending system for requiring at-library book activation. The lending system includes a central system for managing and hosting ebooks, the central system including a storage device and a processor to control a user interface that enables a user to interact with the central system. The central system also includes an access device for activating ebooks at the library. A user may reserve an ebook through the user interface accessed by a remote user device or a library device. The content of the ebook is inaccessible to the user until the ebook is activated, wherein a user may activate the ebook by providing user identification information to the access device, and after the ebook is activated, the user may access the content of the ebook remotely. The present disclosure further includes an ebook lending system for incentivizing library visits by patrons and a digital content lending system for requiring at-library digital content activation.

### TECHNICAL FIELD

The present disclosure relates to the field of digital content lending, and more specifically, to electronic book lending within libraries.

### BACKGROUND

In recent years, electronic books (ebooks) and other electronic media and digital content, such as music and videos, have increased in popularity. Electronic media is currently sold by a variety of distributors, and can be downloaded to a variety of personal devices, such as computers, smart phones, tablets, and ebook readers.

The recent proliferation of electronic media, or digital content, poses unique challenges for libraries or other lending institutions. Current circulation control, catalog management, and library hardware and software are designed for lending physical media, such as paper books, DVD's, CD's, and audio books. Libraries often track the in-library and borrowing use rates of physical media, and use physical media to increase user or patron visits to libraries. These can be important metrics for libraries as they demonstrate their relevance to and use by the local community.

Current electronic book lending systems do not offer the advantages of in-library patron visits and the metrics associated with such visits. Further, it can be difficult for libraries to ensure that local communities benefit from digital content collections. Electronic and digital content may also be corrupted or destroyed by remote lending system failures and hacking. Improvements to digital content and ebook lending would be welcomed.

### SUMMARY

The present disclosure provides several advantages when compared with both the traditional library hardware and software designed for managing physical media collections and the current ebook lending systems. For example, the present invention provides users or patrons with the convenience of electronic books that can be accessed anywhere from a user's or patron's device, while still requiring the user or patron to visit the library to initially activate the content prior to access. Further, the present disclosure increases library visits, which can provide an important metric by which libraries receive funding. The present disclosure provides a method to encourage patrons initially checking out electronic content to encounter other types of content while physically in the library. The present disclosure helps to ensure patrons checking out electronic materials are part of the community by requiring a visit to the library for content activation. The present disclosure further provides a system for incentivizing patrons to increase library engagement by participating in library events, borrowing library materials, making library donations, and permitting access to premium or ‘additional feature’ content.

In one embodiment, the present disclosure includes an electronic book (ebook) lending system for requiring at-library book activation. The lending system includes a central system for managing and hosting ebooks, the central system including a storage device and a processor to control a user interface, wherein the user interface enables a user to interact with the central system. The lending system further includes an access device for activating ebooks at the library. A user may reserve an ebook through the user interface accessed by a remote user device or a library device. In such an embodiment, the content of the ebook is inaccessible to the user until the ebook is activated, wherein a user may activate the ebook by providing user identification information to the access device, and after the ebook is activated, the user may access the content of the ebook remotely.

In another embodiment, the present disclosure includes an ebook lending system for requiring at-library book downloading including a central system for managing and hosting ebooks, the central system including a storage device and a processor to control a user interface, wherein the user interface enables a user to interact with the central system. The lending system further includes a download device for permitting ebook downloading at the library, wherein a user may reserve an ebook through the user interface accessed by a remote user device or a library device. In such an embodiment the ebook cannot be downloaded by the user until the ebook is activated, wherein a user may activate the ebook by providing user identification information to the download device, and after the ebook is activated, the user may download the ebook.

In yet another embodiment, the present disclosure includes an ebook lending system for requiring at-library book activation. The lending system includes a central system for managing and hosting ebooks, the central system including a storage device and a processor to control a user interface, wherein the user interface enables a user to interact with the central system. A user may reserve an ebook through the user interface accessed by a remote user device or a library device. In such an embodiment, the content of the ebook is inaccessible to the user until the ebook is activated, wherein the central system activates the ebook upon receiving confirmation of user presence at the library.

In yet another embodiment, the present disclosure includes an ebook lending system for incentivizing library visits by users. The ebook lending system includes, a central system for managing and hosting ebooks, the central system including a storage device and a processor to control a user interface, wherein the user interface enables a user to interact with the central system. The lending system further includes an incentive device at a library for identifying a user and tracking user actions. In such an embodiment, when a user performs a creditable action and provides identification information to the incentive device, the central system associates activation credits with the user's library account, wherein the user's access to digital content is associated with the user's activation credits.

The present disclosure also includes a digital content lending system for requiring at-library content activation. The digital content lending system includes a central system for managing and hosting digital content, the central system including a storage device and a processor to control a user interface that enables a user to interact with the central system. The digital content lending system further includes an access device for activating digital content at the library. A user may reserve digital content through the user interface accessed by a remote user device or a library device. In such an embodiment, the digital content is inaccessible to the user until the digital content is activated, wherein a user may activate the digital content by providing user identification to the access device, and after the digital content is activated, the user may access the digital content remotely.

In another embodiment, the present disclosure includes a digital content lending system for requiring at-library digital content downloading including a central system for managing and hosting ebooks, the central system including a storage device and a processor to control a user interface, wherein the user interface enables a user to interact with the central system. The lending system further includes a download device for permitting digital content downloading at the library, wherein a user may reserve digital content through the user interface accessed by a remote user device or a library device. In such an embodiment the digital content cannot be downloaded by the user until the digital content is activated, wherein a user may activate the digital content by providing user identification information to the download device, and after the digital content is activated, the user may download the digital content.

In yet another embodiment, the present disclosure includes a digital content lending system for requiring at-library book activation. The lending system includes a central system for managing and hosting digital content, the central system including a storage device and a processor to control a user interface, wherein the user interface enables a user to interact with the central system. A user may reserve a digital content through the user interface accessed by a remote user device or a library device. In such an embodiment, the content of the digital content is inaccessible to the user until the digital content is activated, wherein the central system activates the digital content upon receiving confirmation of user presence at the library.

In yet another embodiment, the present disclosure includes a digital content lending system for incentivizing library visits by users. The digital content lending system includes, a central system for managing and hosting digital content, the central system including a storage device and a processor to control a user interface, wherein the user interface enables a user to interact with the central system. The lending system further includes an incentive device at a library for identifying a user and tracking user actions. In such an embodiment, when a user performs a creditable action and provides identification information to the incentive device, the central system associates activation credits with the user's library account, wherein the user's access to digital content is associated with the user's activation credits.

### BRIEF DESCRIPTION OF DRAWINGS

For a more complete understanding of the present disclosure and its advantages, reference is now made to the following description, taken in conjunction with the accompanying drawings, in which:

FIG. 1 shows components in an electronic book lending system consistent with the present disclosure.

FIG. 2 shows an exemplary access device.

FIG. 3 shows an exemplary download device.

FIGS. 4a-4c show exemplary remote user devices.

FIG. 5 shows an exemplary work flow for requiring at-library active ebook activation.

FIG. 6 shows an exemplary work flow for requiring at-library passive ebook activation.

FIG. 7 shows an exemplary incentive device.

FIG. 8 shows an exemplary work flow for library visit incentives.

The accompanying drawings illustrate various embodiments of the present invention. The embodiments may be utilized, and structural changes may be made, without departing from the scope of the present invention. The figures are not necessarily to scale. Like numbers used in the figures generally refer to like components. However, the use of a number to refer to a component in a given figure is not intended to limit the component in another figure labeled with the same number. Additionally, the terms “user” and “patron” are used interchangeably throughout.

### DETAILED DESCRIPTION

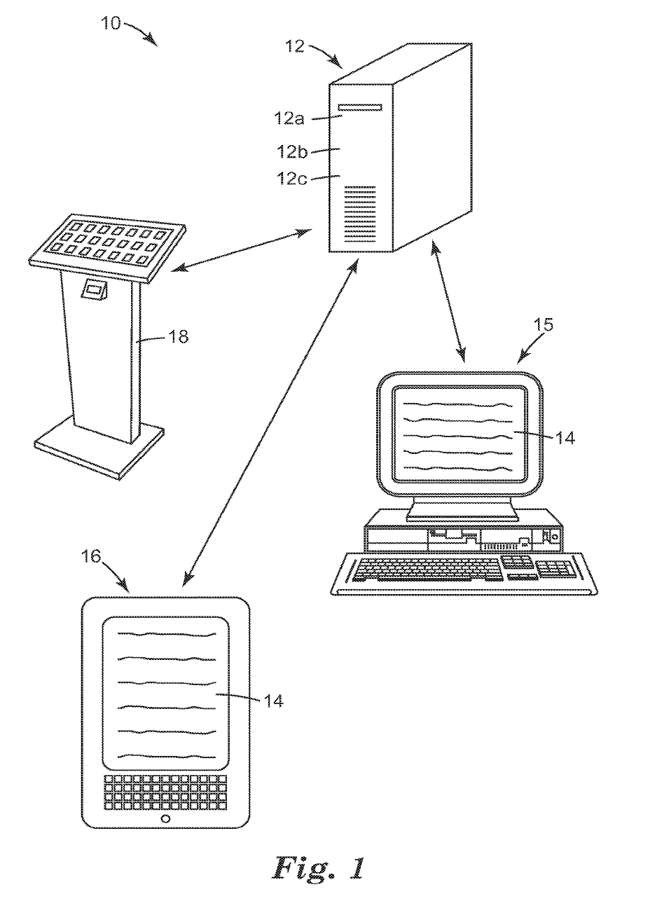

FIG. 1 shows components in an ebook lending system 10 consistent with the present disclosure. As illustrated in FIG. 1, ebook lending system 10 includes a central system 12, a library device 15, a remote user device 16 and an access device 18. Central system 12 may be for example, a computer server as known to one of skill in the art that includes a storage device 12a and a processor 12b. Central system 12 may include multiple servers, computers or other electronic devices. Central system may have a variety of architectures, including multiple layers and a cloud architecture. Other architectures for central system 12 will be apparent to individuals of skill in the art upon reading the present disclosure. Storage device 12a can store and host ebooks and other digital content, such as music, videos, journals, manuscripts, maps, and images. Ebooks, as described in this application include interactive ebooks that allow a user to engage with the content presented. Ebooks also ebook applications. Storage device 12a may also host patron account information, rules related to checking in and checking out digital content, encryption information related to encrypting the ebooks or digital content, and any other management information for administrating the ebook lending system.

Central system 12 also includes communication module 12c which allows it to communicate and interface with other electronic devices. Types of communication facilitated include a variety of wired or wireless communication protocols as currently known in the industry. Local Area Networks (LAN) implementing Ethernet connect the central system 12 to library device 15 or access device 18. Communication may also be implemented through Wireless Local Area Networks (WLAN) or Cellular. Combination LAN and WLAN or Cellular communication systems may also be implemented. As an example, communication between the central system 12 and library device 15 may be LAN via Ethernet and communication between the central system 12 and the remote user device 16 may utilize Cellular. Other communication methods and permutations may also be implemented as will become available with the ongoing development of technology and will be apparent to one of skill in the art.

While central system 12 may be configured to store and manage a variety of patron account information and other circulation management data, it may also be configured to interface with an integrated library system (ILS) as used by a library to manage circulation of its physical collection. Central system 12 may use communication module 12c as described above to interface with an ILS or other library patron account and circulation management system.

While not shown in FIG. 1, central system 12 may include user interface components such as a display, keyboard, mouse or other items that allow a user to manage central system 12. Alternatively, central system 12 may be accessed remotely by a computer or other device through communication module 12, with the appropriate authorizations.

Ebook lending system 10 further interfaces with a library device 15 or a remote user device 16. Library device 15 may be a traditional computer configured for patron use, as found in many libraries today. Remote user device 16 may be a personal computer owned or accessed by a patron or a tablet, such as the Apple™ iPad made by Apple of Cupertino, Calif., or an android tablet, such as the Samsung Galaxy Tab 10.1 made by Samsung of Ridgefield Park, N.J. Remote user device 16 may also be a mobile telephone, such as a smart phone, a laptop computer, an electronic reader, a mobile telephone, or a television. Remote user device 16 may be any device capable of rendering digital content for user consumption. Library device 15 may also be any of the devices listed as examples of remote user devices 16, with the difference that library device 15 is owned or managed by a library. As such, library device 15 may have preset authentication and a variety of restrictions associated with the device.

Library device 15 and remote user device 16 may be used to access user interface 14, which is hosted by central system 12. User interface 14 enables a patron or a user to interact with the central system 12. In one embodiment, a user may use the user interface 14 to interface with the central system 12 to reserve an ebook. Reserving an ebook may include downloading an ebook file, wherein the content of the ebook is inaccessible to the user until the ebook is activated. Reserving an ebook may also include simply placing a reservation on the ebook, where the ebook is associated with the particular user's or patron's account for a set amount of time, such as a predetermined activation period. Such a period may be chosen by a library, and may be a relatively short amount of time, such as in the range of one to five days, or more specifically as an example, three days. In such a configuration, if the user does not activate the ebook by providing user identification information to a device such as access device 18 within a predetermined activation period, the ebook reservation will expire. Further, after the ebook is activated, the content of the ebook may become inaccessible to the user after a predetermined loan period. A predetermined loan period may be an amount of time set by a library, a publisher or a manager or a system host for an ebook lending system 10. It may be any desired period time, such as in the range of one week to four weeks, and as a specific example, two weeks.

After an ebook has been activated such that the ebook content may be accessed, a user may use a remote patron device 16 or a library device 15 to access the ebook content remotely or from any location. When an ebook is activated, the activation is for a particular user. Each user wishing to check out the particular ebook or digital content will be required to individually activate it.

Access device 18 may be located inside or at the exterior of a library. An example of an access device 18 located at the exterior of a library would be an access device 18 mounted to an outside wall of a library, or incorporated into a return bin outside of the library on library property. Access device 18 may be a variety of devices, such as a patron self check-out device, a traditional computer configured to perform the required functions, with any necessary peripherals added, or a specially designed device as shown in FIG. 1. A patron or user may interact with access device 18 to provide patron identification information to access device 18. Upon receiving the patron or user identification information, access device 18 can communicate with central system 12 to determine whether the patron has reserved any ebooks. If the patron or user has ebooks associated with their account, the access device 18 may require the patron or user to select which particular ebooks will be activated, or may automatically activate all ebooks associated with the patron or user or their account.

In some embodiments, access device 18 is a biometric access device, and the user identification information includes at least one of a finger print, iris recognition, facial recognition and voice recognition. In other embodiments, the user information may be a patron or user ID number, library card barcode, or patron or user account login information, or other information.

While access device 18 is shown in FIG. 1, a download device as shown in and described with respect to FIG. 3 may also interface with other components shown in ebook lending system 10 in FIG. 1 in the same or similar ways to the access device 18.

While the term “ebook” is used throughout in describing lending system 10, such a lending system may also be used for digital content generally, and the term ebook is not intended to be limiting.

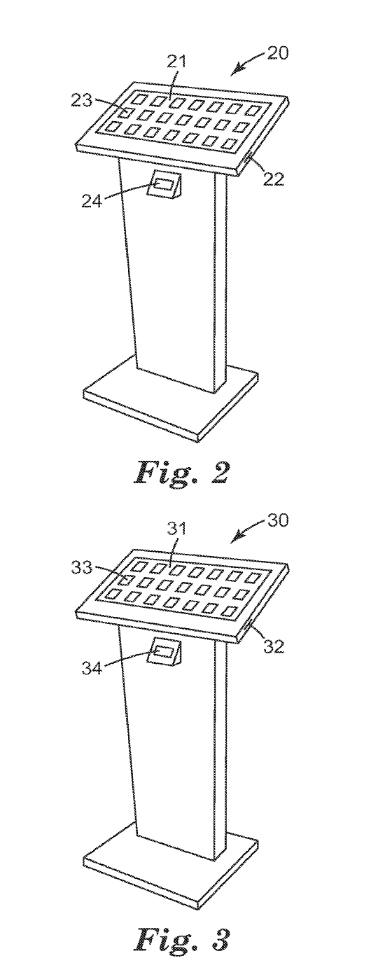

FIG. 2 shows an exemplary access device 20. As mentioned elsewhere, an access device 20 may be a variety of devices, such as a patron self check-out device, a traditional computer configured to perform the required functions, with any necessary peripherals added, or a specially designed device. Access device includes a user interface 21, a patron ID component 22, an item ID component 23 and communication module 24. User interface 21 includes a display as shown. In some instances, the display may be a touch screen. User interface 21 may include a keyboard, other buttons by which the user may make various selections, or a touch pad allowing a user to interact with other features in user interface 21, such as a display.

Patron ID component 22 allows a user to provide identification information to the access device 20. Patron ID component 22 is illustrated as being a card reader in FIG. 2. It may read a magnetic stripe from a patron's library card or other type of identification card, such as a driver's license, national ID card, credit card, or other card. A patron ID component 22 is designed such that upon a patron providing identification information to access device 20, access device 20 is able to locate a patron's account with the library or lending institution, either based on information stored in access device 20, through communication with a central system or an integrated library system.

In other embodiments, the identification information required by access device 20 may be biometric, so that a patron is not required to carry additional identifying documents or cards with them. For example, patron ID component may be a biometric component such as a finger print device, an iris recognition, facial recognition or voice recognition.

In yet other embodiments, patron ID component 22 may be incorporated into user interface 21. For example, a patron may be required to enter a library or lending institution ID number into a field on a display, or to log in through the display using account login information, such as the same information a patron may use when logging into a library account online.

Item ID component 23 allows a patron to select a particular item for reservation or activation. Item ID component 23 may be a key pad that allows a patron to select a particular ebook displayed by navigating using arrows, numbers or letters on the keypad. Item ID component may be incorporated into the user interface 21, as may be the case when the display includes a touch screen.

Access device communication module 24 allows access device 21 to communicate with other devices in an ebook lending system, such as a central system, a library device, a remote user device or even a database such as an ILS. Communication module 24 may include a variety of communication capabilities and protocols, such as LAN, WLAN, Infrared, or Bluetooth, and other communication methods as will become available with the ongoing development of technology.

FIG. 3 shows an exemplary download device 30. Download device 30 may have components similar to access device 20 in FIG. 2. Download device 30 as shown in FIG. 3 includes user interface 31, patron ID component 32, item ID component 33 and communication module 34. Download device 30 may be located in or at a library, such as at the exterior of a library, and permits ebook downloading. Download device 30 permits a user to download an ebook or digital content after a user has provided identification information to the download device. Download device 30 may then activate all ebooks or digital content associated with that particular patron or user, or it may activate only ebooks or digital content permitted by the central system or selected by the patron. Ebooks or digital content may be downloaded at the library directly from download device 30 to a remote user device or library device, or may be downloaded remotely by a remote user device or library device.

User interface 31 includes a display as shown. In some instances, the display may be a touch screen. User interface 31 may include a keyboard, other buttons by which the user may make various selections, or a touch pad allowing a user to interact with other features in user interface 31, such as a display.

Patron ID component 32 allows user to provide identification information to the download device 30. Patron ID component 32 is illustrated as being a card reader in FIG. 3. It may read a magnetic stripe from a patron's library card or other type of identification card, such as a driver's license, national ID card, credit card, or other card. A patron ID component 32 is designed such that upon a patron providing identification information to download device 30, download device 30 is able to locate a patron's account with the library or lending institution, either based on information stored in download device 30, through communication with a central system or an integrated library system.

In other embodiments, the identification information required by download device 30 may be biometric, so that a patron is not required to carry additional identifying documents or cards with them. For example, patron ID component may be a biometric component such as a finger print device, an iris recognition, facial recognition or voice recognition.

In yet other embodiments, patron ID component 32 may be incorporated into user interface 31. For example, a patron may be required to enter a library or lending institution ID number into a field on a display, or to log in through the display using account login information, such as the same information a patron may use when logging into a library account online.

Item ID component 33 allows a patron to select a particular item for reservation or activation. Item ID component 33 may be a key pad that allows a patron to select a particular ebook displayed by navigating using arrows, numbers or letters on the keypad. Item ID component may be incorporated into the user interface 31, as may be the case when the display includes a touch screen.

Download device communication module 34 allows download device 30 to communicate with other devices in an ebook lending system, such as a central system, a library device, a remote user device or even a database such as an ILS. Communication module 34 may include a variety of communication capabilities and protocols, such as LAN, WLAN, Infrared, Cellular, or

Bluetooth and other communication methods as will become available with the ongoing development of technology.

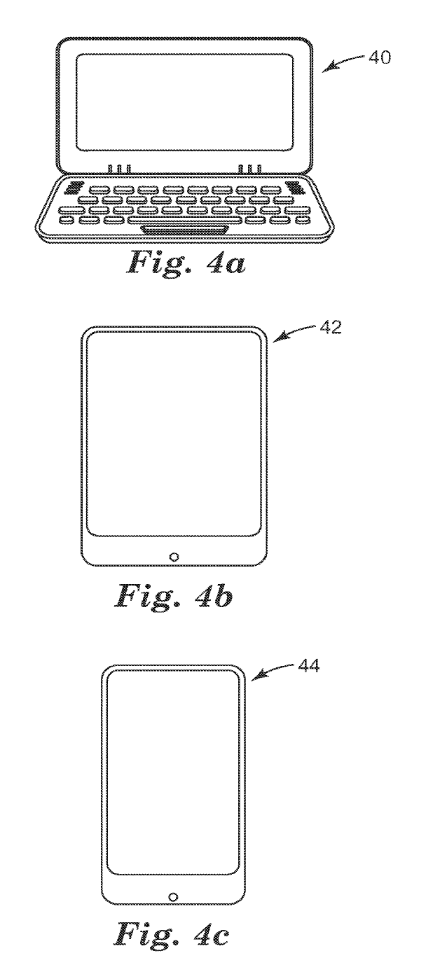

FIGS. 4a-4c show several exemplary remote user devices. FIG. 4a shows a remote user device as a personal computer 40. Personal computer 40 may be a desktop computer or a laptop computer as are well known, and may be configured to access the user interface hosted by the central system for purposes of ebook or digital content lending through an internet connection or by using an installed application.

FIG. 4b shows a remote user device as a tablet 42. Tablet 42 may be any tablet with appropriate capabilities such as the Apple™ iPad made by Apple of Cupertino, Calif., or an android tablet, such as the Samsung Galaxy Tab 10.1 made by Samsung of Ridgefield Park, N.J.

FIG. 4c shows a remote user device as a mobile telephone 44. Mobile telephone 44 shown is a smart phone. A smart phone is typically a mobile phone built on a mobile computing platform, and often including features such as portable media players, cameras, GPS navigation units, touch screens, and web browsers. A user may use a web browser or a downloaded application to access the user interface hosted by a central system to reserve, download and access ebooks and digital content.

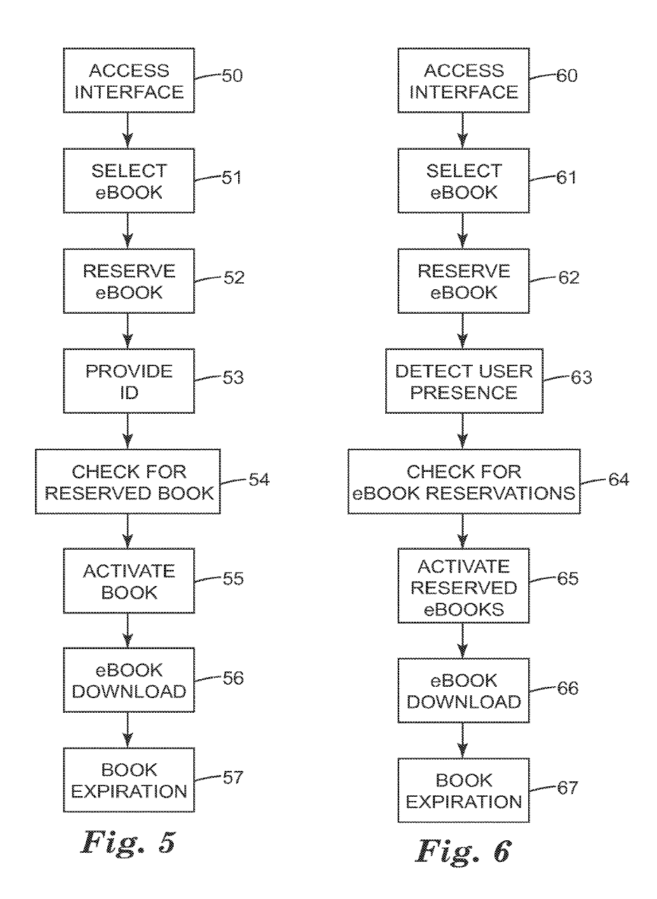

FIG. 5 shows an exemplary work flow for requiring at-library active ebook activation. Step 50, access interface, allows a patron or user to access a user interface hosted by a central system 12 as described in FIG. 1. As described, the user interface may be accessed by a remote user device or a library device.

In step 51, a user or patron may select an ebook or other digital content. They may choose the desired ebook or digital content from a library's or lending institution's catalog of electronic material. In some instances, the catalog may vary based on the location from which the catalog is being accessed. For example, a catalog accessed from inside a library or lending institution, or by a library device may make more titles available to be selected than a catalog accessed by a remote user device.

In step 52, a user or patron may reserve the selected ebook or digital content, so that the particular ebook or other content is associated with the patron's account and is made unavailable for reserve by another patron or user. In one embodiment, a user or patron may download the ebook or digital content at this step; however, in such a case, the content of the ebook is inaccessible to the user until the ebook is activated. Reserving an ebook may also include simply placing a reservation on the ebook, where the ebook is associated with the particular user's or patron's account for a set amount of time, such as a predetermined activation period. Such a period may be chosen by a library, and may be a relatively short amount of time, such as in the range of one to five days, or more specifically as an example, three days. In such a configuration, if the user does not activate the ebook by providing user identification information to a device such as access device or download device within a predetermined activation period, the ebook reservation will expire.

In step 53, a user or patron may provide user identification information to an access device or a download device. This step may take a variety of forms based on the type of user identification required. The type of user identification required can include an identification card, number, login information, biometric information, or other identification information.

In step 54, upon receiving identification information from a patron or user, the access or download device checks to see if there are any reserved ebooks or other digital content associated with the patron's or user's account. If there are reserved ebooks associated with the user's or patron's account, the access or download device may automatically activate all the reserved ebooks. In another embodiment, the user or patron may choose one or a subset of the reserved ebooks to activate. Some ebook lending systems may allow a user or patron to activate only a single ebook or piece of digital content at a time.

In step 55, the access or download device interacts with a central system to activate the ebook. In some instances, activating the ebook may allow a user to access the content of a previously downloaded ebook. In other instances, activation may allow a user to download and immediately access the content of a reserved ebook.

In step 56, a user may access the content or download the ebook or digital content as described above.

In step 57, access to the ebook or the digital content by a particular patron or user may expire after a predetermined loan period. A predetermined loan period may be an amount of time set by a library, a publisher or a manager or a system host for an ebook lending system 10. It may be any desired period of time, such as in the range of one week to four weeks, and as a specific example, two weeks.

FIG. 6 shows an exemplary work flow for requiring at-library passive ebook activation. FIG. 6 differs from FIG. 5 in that, for an ebook or other digital content to be activated, a patron's or user's presence at the library is sensed without requiring the patron or user to interact with an access or download device. Once the patron's or user's presence at the library is sensed, ebooks or digital content reserved by the patron are automatically activated.

Step 60, access interface, allows a patron or user to access a user interface hosted by a central system 12 as described in FIG. 1. As described, the user interface may be accessed by a remote user device or a library device.

In step 61, a user or patron may select an ebook or other digital content. They may choose the desired ebook or digital content from a library's or lending institution's catalog of electronic material. In some instances, the catalog may vary based on the location from which the catalog is being accessed. For example, a catalog accessed from inside a library or lending institution, or by a library device may make more titles available to be selected than a catalog accessed by a remote user device.

In step 62, a user or patron may reserve the selected ebook or digital content, so that the particular ebook or other content is associated with the patron's account and is made unavailable for reserve by another patron or user. In one embodiment, a user or patron may download the ebook or digital content at this step; however, in such a case, the content of the ebook is inaccessible to the user until the ebook is activated. Reserving an ebook may also include simply placing a reservation on the ebook, where the ebook is associated with the particular user's or patron's account for a set amount of time, such as a predetermined activation period. Such a period may be chosen by a library, and may be a relatively short amount of time, such as in the range of one to five days, or more specifically as an example, three days. In such a configuration, if the user does not activate the ebook by providing user identification information to a device such as access device or download device within a predetermined activation period, the ebook reservation will expire.

In step 63, a user's or patron's presence at the library is detected. This may be achieved in a variety of ways. For example, consistent with the present application, the patron or user may not have to be physically present in the library, but rather within a geographical perimeter around the library. A patron may simply walk past the library, and if the patron's path is within the geographical perimeter, this may be sufficient for detecting the patron's presence at the library.

A patron's presence within a geographical perimeter can be confirmed based on a patron or user carrying a remote user device with location and communication capabilities. The device may have an application on it such that it transmits location information for the patron to the central system, and in that way, the central system detects the patron's or user's presence at the library. The location of the library may appear on a remote user device application as Global Positioning System (GPS) or as other spatial coordinates. The application will monitor the coordinates of the remote user device in relation to a user definable geographical perimeter around the coordinates of the library. A patron's presence at the library may also be detected by a patron connecting a remote user device to a library wireless network. The central system may then receive confirmation from the remote user device that the patron is at the library or within a geographical perimeter around the library.

In step 64, upon detecting the user's or patron's presence at the library, the central system checks to see if there are any reserved ebooks or other digital content associated with the patron's or user's account.

In step 65, if there are reserved ebooks associated with the user's or patron's account, the central system may automatically activate all the reserved ebooks. Only a single ebook or piece of digital content, or other a limited number of digital items may be activated based on an order of priority established by the patron or user. In some instances, activating the ebook may allow a user to access the content of a previously downloaded ebook. In other instances, activation may allow a user to download and immediately access the content of a reserved ebook.

In step 66, a user may access the content or download the ebook or digital content as described above.

In step 67, access to the ebook or the digital content by a particular patron or user may expire after a predetermined loan period. A predetermined loan period may be an amount of time set by a library, a publisher or a manager or a system host for an ebook lending system. It may be any desired period time, such as in the range of one week to four weeks, and as a specific example, two weeks.

FIG. 7 shows an exemplary incentive device 70. An incentive device 70 may be similar to an access device or a download device. An incentive device 70 may be a variety of devices, such as a patron self check-out device, a traditional computer configured to perform the required functions, with any necessary peripherals added, or a specially designed device. Incentive device 70 includes a user interface 71, a patron ID component 72, a patron action confirmation component 73 and a communication module 74. User interface 71 includes a display as shown. In some instances, the display may be a touch screen. User interface 71 may include a keyboard, other buttons by which the user may make various selections, or a touch pad allowing a user to interact with other features in user interface 71, such as a display.

Patron ID component 72 allows user to provide identification information to incentive device 70. Patron ID component 72 is illustrated as being a card reader in FIG. 7. It may read a magnetic stripe from a patron's library card or other type of identification card, such as a driver's license, national ID card, credit card, or other card. A patron ID component 72 is designed such that upon a patron providing identification information to incentive device 20, incentive device 70 is able to locate a patron's account with the library or lending institution, either based on information stored in incentive device 70, through communication with a central system or an integrated library system.

In other embodiments, the identification information required by incentive device 70 may be biometric, so that a patron is not required to carry additional identifying documents or cards with them. For example, patron ID component may be a biometric component such as a finger print device, an iris recognition, facial recognition or voice recognition.

In yet other embodiments, patron ID component 72 may be incorporated into user interface 71. For example, a patron may be required to enter a library or lending institution ID number into a field on a display, or to log in through the display using account login information, such as the same information a patron may use when logging into a library account online.

Patron action confirmation component 73 provides a way for a patron to confirm that he or she has taken a particular action that will be creditable to the patron's account. Examples of such an action include checking out a physical book, volunteering at a library, making a donation to the library, confirming a visit to the library or attending a library event. Patron action component may be, for example, a barcode scanner or RFID reader, where a patron scans a barcode or RFID tag received upon completing a particular action, such as completing volunteer time for the library. It may be a card reader, a field shown in user interface 71 that allows a patron to enter information or any other device that allows a patron to confirm they have taken a creditable action.

Incentive device communication module 74 allows access device 71 to communicate with other devices in an ebook lending system, such as a central system, a library device, a remote user device or even a database such as an ILS. Communication module 74 may include a variety of communication capabilities and protocols, such as LAN, WLAN, Infrared, or, Bluetooth, and other communication methods as will become available with the ongoing development of technology.

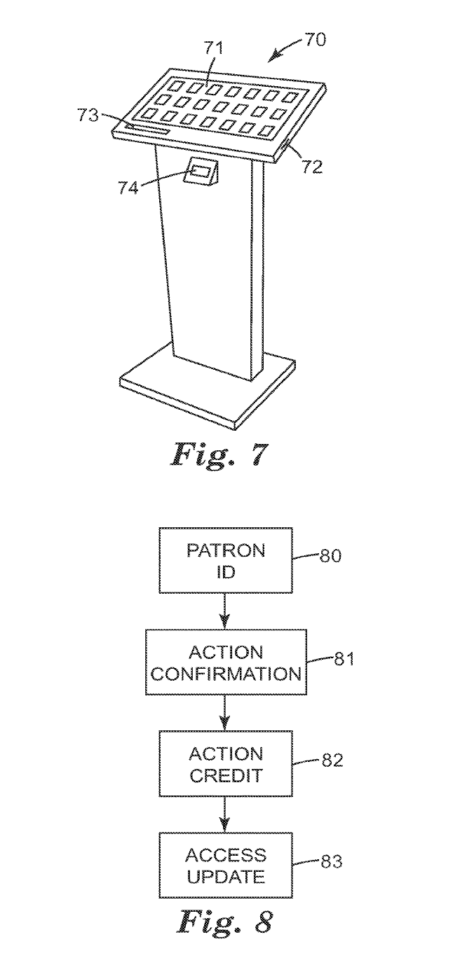

FIG. 8 shows an exemplary work flow for library visit incentives. In step 80, patron identification, a user or patron may provide user identification information to an access device or a download device. This step may take a variety of forms based on the type of user identification required. The type of user identification required can include an identification card, number, login information, biometric information, or other identification information.

In step 81, after providing identification information to the incentive device, the patron provides action confirmation to the incentive device. Examples of such an action include checking out a physical book, volunteering at a library, making a donation to the library, confirming a visit to the library or attending a library event. Patron action confirmation may include scanning a barcode or RFID tag the patron received upon completing a particular action, such as completing volunteer time for the library. A patron may also swipe a card with a magnetic stripe or enter information into a field on a user interface that allows a patron to enter confirmation information, such as a number or pass code received upon completion of a creditable action.

In step 82, the central system assigns the patron's account with credits based upon the creditable action performed by the patron. The quantity of credits assigned to the patron may vary based on the action taken. For example, a patron simply confirming a library visit may receive fewer credits than a patron who volunteered at a library for a given period of time.

In step 83, a patron's access to digital content is updated based on the patron's activation credits. Credits may accumulate relative to a patron's account, or credits may be redeemed for particular access privileges. For example, credits, whether accumulated or redeemed, may be used for an increased selection of ebook catalog titles, for ebook activation permission, for access to additional types of digital content, such as audio books, music and videos, for extending lending period beyond a predetermined library standard lending period and for reducing hold periods. For example, a patron may redeem credits to jump to a higher priority on a hold list.

Each of the steps shown in FIGS. 5, 6 and 8 are intended to be exemplary. There may be particular system configurations consistent with the present disclosure which require more or fewer steps; however, such configurations will be apparent to one of skill in the art upon reading the present disclosure.

### Examples

Example 1 illustrates an exemplary in-library incentive program consistent with the present disclosure.

Each transaction occurring within an in-library lending system provides immediate and expansive benefits to a patron. As a patron interacts with a library or access device, library and lending information is presented to the user through the user interface. Upon accessing and downloading a reserved eBook, the patron interacts with a display on an incentive device that presents immediately occurring or recurring library events such as author visits, book signings, interactive learning opportunities, “do it yourself” activities, or other ways a patron may become more involved with the library or borrowed content. The user interface is updated based upon a specific library of events schedule or may reflect the material that the patron has reserved or accessed. If a patron downloads an ebook with subject matter specific to cooking, then the user interface may display upcoming events that are specific to recipes or opportunities to learn about cooking. While the user interface displays upcoming events the number of credits associated with the event is also displayed. Each ebook or digital content or other creditable action is worth a predefined number of credits or tokens which are associated with a patron's account. One credit for a single book or two or more for the entire series. The user interface of the incentive device displays how many credits or tokens are currently accumulated and how many are available to trade for additional content. Credits or tokens are used to access or unlock premium content, reserve content for longer durations, or provide longer periods to checkout content. If a patron continues to checkout ebooks related to baking or cooking, then the credit or token program may be used to reserve the first available copy of the next major cook book release. The credit or token program would enable the patron to redeem the credit for the right to reserve the first copy and to keep the content for one week or other definable period of time longer than a regular checkout period.

Although the present disclosure has been described with reference to preferred embodiments, those of skill in the art will recognize that changes may be made in form and detail without departing from the spirit and scope of the present disclosure.

What is claimed is:

1. An electronic book (ebook) lending system for requiring at-library book activation comprising:
a central system for managing and hosting ebooks, the central system including a storage device and a processor to control a user interface, wherein the user interface enables a user to interact with the central system;
an access device at a library for activating ebooks;
wherein a user may reserve an ebook through the user interface accessed by a remote user device or a library device;
wherein the content of the ebook is inaccessible to the user until the ebook is activated, wherein a user may activate the ebook by providing user identification information to the access device, and after the ebook is activated, the user may access the content of the ebook remotely.

2. The system of claim 1, wherein the access device is a self check-out device.

3. The system of claim 1, wherein the access device is a biometric access device, and wherein the user identification information includes at least one of a finger print, iris recognition, facial recognition and voice recognition.

4. The system of claim 1, wherein if the user does not activate the ebook by providing user identification information within a predetermined activation period, the ebook reservation will expire.

5. The system of claim 1, wherein after the ebook is activated, the content of the ebook becomes inaccessible to the user after a predetermined loan period.

6. The system of claim 1, wherein the remote user device includes at least one of an electronic reader, a tablet, a laptop computer, a mobile telephone, a television and a desktop computer.

7. The system of claim 1, wherein the access device is located at the exterior of the library.

8. An electronic book (ebook) lending system for requiring at-library book downloading comprising:
a central system for managing and hosting ebooks, the central system including a storage device and a processor to control a user interface, wherein the user interface enables a user to interact with the central system;
a download device at a library for permitting ebook downloading;
wherein a user may reserve an ebook through the user interface accessed by a remote user device or a library device;
wherein the ebook cannot be downloaded by the user until the ebook is activated, wherein a user may activate the ebook by providing user identification information to the download device, and after the ebook is activated, the user may download the ebook.

9. The system of claim 8, wherein the download device is a self check-out device.

10. The system of claim 8, wherein after the ebook is downloaded, the ebook may be downloaded remotely by the user.

11. The system of claim 8, wherein after the ebook is activated, the ebook may be downloaded by the user from the download device.

12. The system of claim 8, wherein the download device includes biometric identification capabilities, and wherein the user identification information includes at least one of a finger print, iris recognition, facial recognition and voice recognition.

13. The system of claim 8, wherein if the user does not download the ebook within a predetermined download period, the ebook reservation will expire.

14. The system of claim 8, wherein the remote user device includes at least one of an electronic reader, a tablet, a laptop computer, a mobile telephone, a television and a desktop computer.

15. The system of claim 8, wherein the access device is located at the exterior of the library.

16. An electronic book (ebook) lending system for requiring at-library ebook activation comprising:
a central system for managing and hosting ebooks, the central system including a storage device and a processor to control a user interface that enables a user to interact with the central system;
wherein a user may reserve an ebook through the user interface accessed by a remote user device or a library device;
wherein the content of the ebook is inaccessible to the user until the ebook is activated, wherein the central system activates the ebook upon receiving confirmation of user presence at the library.

17. The system of claim 16, wherein user presence at the library is based on a geographical perimeter around the library.

18. The system of claim 16, wherein user presence at the library is determined by connection of the user device to a library wireless network.

19. The system of claim 16, wherein the user device transmits confirmation of user presence at the library to the central system based on location capabilities of the user device.

20. The system of claim 16, wherein if the user does not activate the ebook by providing user authentication information within a predetermined activation period, the ebook reservation will expire.

21. The system of claim 16, wherein after the ebook is activated, the content of the ebook becomes inaccessible to the user after a predetermined loan period.

22. An electronic book lending system for incentivizing library visits by users, comprising:
a central system for managing and hosting ebooks, the central system including a storage device and a processor to control a user interface that enables a user to interact with the central system;
an incentive device at a library for identifying a user and tracking user actions;
wherein when a user performs a creditable action and provides identification information to the incentive device, the central system associates activation credits with the user's library account, wherein the user's access to ebook content is associated with the user's activation credits.

23. The system of claim 22, wherein a creditable action includes at least one of checking out a book, volunteering at a library, making a donation to the library, confirming a visit to the library, and attending a library event.

24. The system of claim 22, wherein content access includes at least one of an increased selection of catalog titles, ebook activation permission, access to additional types of digital content, extended lending periods, and reduced hold periods.

25. The system of claim 22, wherein the incentive device includes a patron interface, wherein the interface enables the patron to select the type of creditable action, provide a confirmation code, and provide identification information.

26. A digital content lending system for requiring at-library content activation comprising:
a central system for managing and hosting digital content, the central system including a storage device and a processor to control a user interface that enables a user to interact with the central system;
an access device at a library for activating digital content;
wherein a user may reserve digital content through the user interface accessed by a remote user device or a library device;
wherein the digital content is inaccessible to the user until the digital content is activated, wherein a user may activate the digital content by providing user identification to the access device, and after the digital content is activated, the user may access the digital content remotely.

27. The system of claim 26, wherein the digital content includes at least one of an electronic book, an audio book, music and video.
